(19) United States
(12) Patent Application Publication
(10) Pub. No.: US 2008/0180014 A1
(43) Pub. Date: Jul. 31, 2008

(54) LED heat sink

(75) Inventors: Jing-Wen Tzeng, Luchu Hsiang (TW); Shih-Hui Chen, Luchu Hsiang (TW)

Correspondence Address: TROXELL LAW OFFICE PLLC, SUITE 1404, 5205 LEESBURG PIKE, FALLS CHURCH, VA, 22041, US

(73) Assignee: TENNRICH INTERNATIONAL CORP.

(21) Appl. No.: 11/699,071

(22) Filed: Jan. 29, 2007

(51) Int. Cl. H01K 1/58

(52) U.S. Cl. 313/46

(57) ABSTRACT

A heat sink for a light emitting diode includes a light emitting diode disposed on a circuit board; a through hole is provided on the circuit board corresponding to where the light emitting diode is located; a heat sink is disposed to the through hole; the heat sink is secured to the circuit board by means of the through hole to directly contact the light emitting diode; and the heat generated from the light emitting diode in operation is effectively dissipated by the heat sink.

### BACKGROUND OF THE INVENTION

(a) Field of the Invention

The present invention is related to a heat sink, and more particular, to one that is adapted to a light emitting diode to effectively promoting heat dissipation results.

(b) Description of the Prior Art

Whereas a light emitting diode (LED) is the device featuring the least complicated and most popularly applied in a photo-electronic semiconductor, the work principle of the LED relates to an operation on a PN junction of positive bias. With the positive bias, massive electric holes are inputted into the P side while massive electrons are injected into the N side. Both of these electric holes and electrons from both are as will respectively release small amount of carriers to the other side in a void are a so that at the moment when massive carriers are incorporated to each other in the void are a, energy system equivalent photons are eradiated to produce light emitting effects. The application range of the light emitting diode has transformed from indicator with comparatively weaker light emitting efficiency up to lighting fixtures with high luminance including highly powerful intensity of traffic signs, interior and exterior lighting of automobiles, and commercial billboards in a fast and wide-spreading development. Breakthroughs achieved in promoting the light emitting effects have been reported on after another; yet the problem of dissipation of high heat generated during the light emitting fails an effective solution due to that the LED is packed in a transparent colloid. As a result, once electrically conducted, resistance drops to bring down the luminance due to failure in effective dissipation of the heat. Therefore, how to effective cool down the temperature of the crystal when electrically conducted so to increase light emitting efficiency, improve luminance, and extend longer service life has become an issue pending urgent solution in the trade.

As illustrated in FIG. 1 of the accompanying drawings for a heat sink construction adapted to an LED of the prior art, a circuit layer (not illustrated) is provided on a circuit board 21; a light emitting chip 11 is mounted to the circuit layer, followed with bonding a wire 12 to connect its corresponding circuit on the circuit board 21 before being molding with an adhesive layer 13 to form a light emitting diode 1. Whereas the LED 1 is connected through the circuit on the circuit layer, the LED 1 may be interconnected to and subject to the control by an external control/drive circuit through the circuit layer.

A heat sink 23 is fixed using a thermal adhesive 22 to where below the circuit board 21 of the LED 1 so that heat generated by the working LED 1 is transmitted by the thermal adhesive 22 to the heat sink 23 for multiple fins allowing a greater surface are a disposed on the heat sink to contact the ambient air for fast heat dissipation. However, it is impossible to effectively and completely dissipate the heat generated from the LED 1 since it indirectly contacts the heat sink 23 via the thermal adhesive 22 to transmit the heat.

### SUMMARY OF THE INVENTION

The primary purpose of the present invention is to provide a heat sink for an LED to effectively dissipate the heat. To achieve the purpose, the LED is disposed on a circuit board and a through hole is provided to the circuit board at where in opposition to that of the LED; a heat sink is disposed in the through hole and secured in position in relation to the circuit board by means of the through hole while permitting direct contact the LED for the heat generated by the working LED to be effectively dissipated from the heat sink.

### BRIEF DESCRIPTION OF THE DRAWINGS

FIG. 1 is a schematic view showing a heat sink construction of an LED of the prior art.

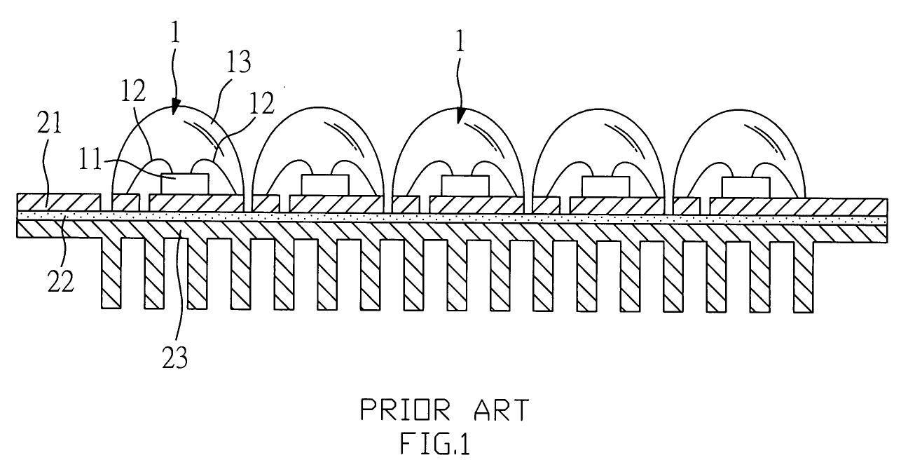

FIG. 2 is a schematic view showing a heat sink construction of a first preferred embodiment of the present invention.

FIG. 3 is a schematic view showing another construction of the heat sink of the first preferred embodiment of the present invention.

FIG. 4 is a schematic view showing a heat sink construction of a second preferred embodiment of the present invention.

FIG. 5 is a schematic view showing a heat sink construction of a third preferred embodiment of the present invention.

### DETAILED DESCRIPTION OF THE PREFERRED EMBODIMENTS

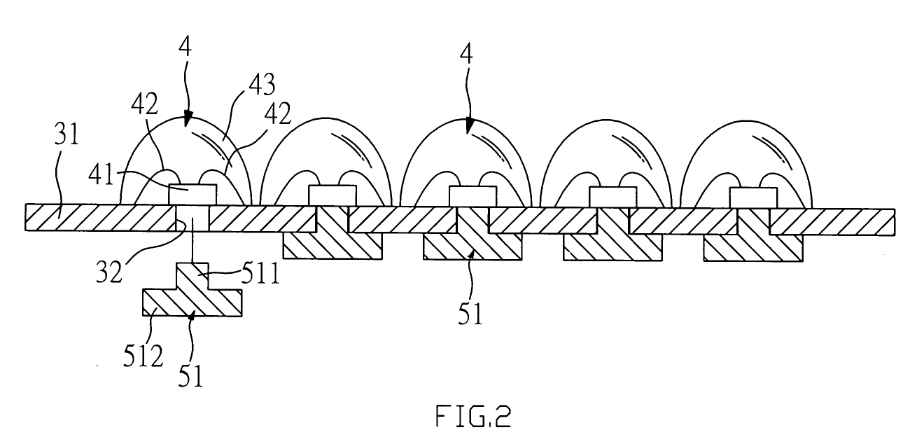

Referring to FIG. 2 for a light emitting diode heat sink construction of the present invention, a circuit layer (not illustrated) is disposed on a circuit board 31, a light-emitting chip 41 is mounted to the circuit layer, and a gold plated wire 42 is bonded to connect its corresponding circuit on the circuit board 31 before being molded into an adhesive layer 43 to become a light emitting diode 4.

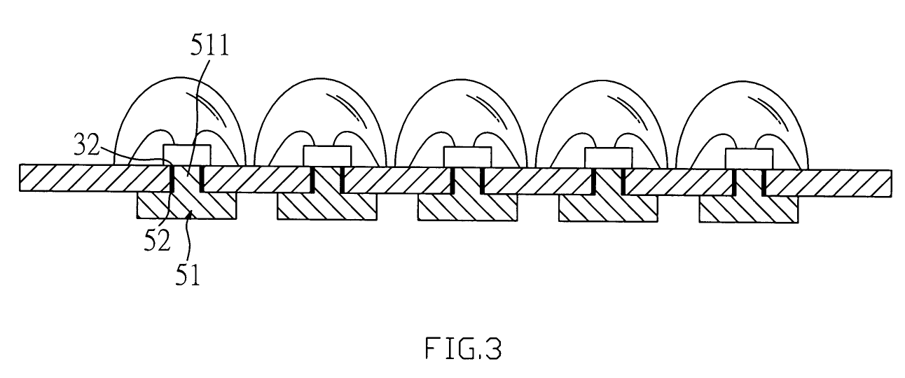

A through hole 32 is disposed on the circuit board 31 corresponding to where the light-emitting chip 41 is located. The through hole 32 is inserted with a heat dissipation means to directly contact and cool the light emitting chip and cool it. The heat sink means relates to a heat sink 51 made of metal (aluminum or copper), ceramic compound, graphite compound or polymer admixed with metal oxides. The heat sink 51 penetrates into the through hole 32 to define a locating portion 511, a heat dissipation portion 512 providing a greater contact surface for heat dissipation extends further from the locating portion 511. A locating means, e.g., an adhesive 52, is provided to where between the through hole and the heat sink 51 to secure the heat sink 51 as illustrated in FIG. 3, or the heat sink 51 is secured to the through hole by using a soldering method. The adhesive 52 may be related to a polymer, thermal adhesive, thermal past, or phase change material (PCM).

In practice, the heat sink 51 is secured to the circuit board 31 in position by means of the through hole 32 so to direct contact the light-emitting chip 41. Whereas the heat sink 51 is provided with a heat dissipation portion 512 with a greater contact surface to permit the heat generated from the working light emitting diode 4 to be effectively dissipated, thus for the light emitting chip 41 when electrically conducted to effectively lower its temperature, and in turn promotes its light emitting power, increase its luminance and extend its service life.

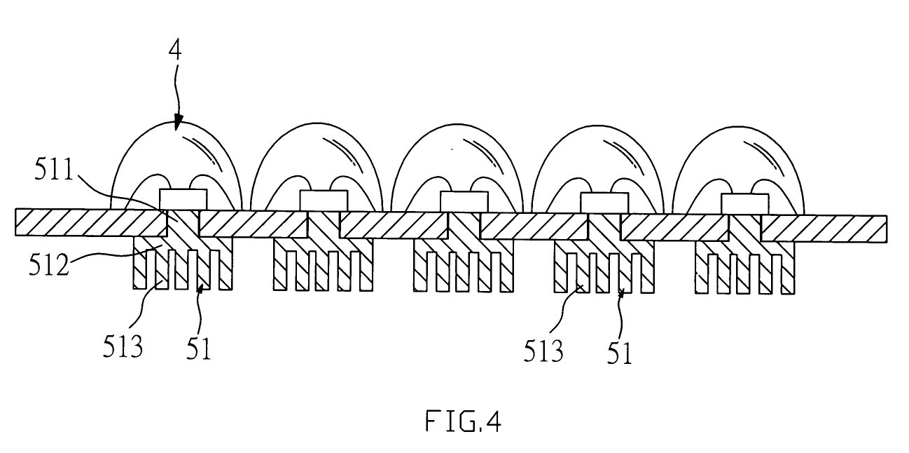

As illustrated in FIG. 4, the heat dissipation portion 5 in a second preferred embodiment of the present invention is made in a form of multiple fins 513 to increase the contact are a with the air for those fins 513 to promote heat dissipation efficiency.

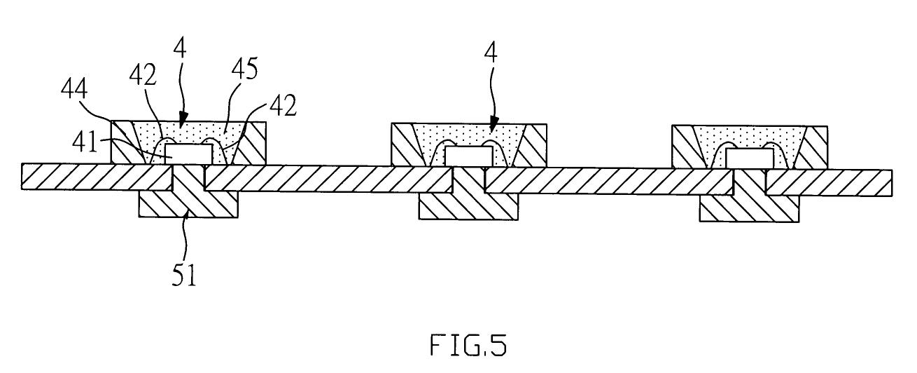

Now referring to FIG. 5 for a third preferred embodiment of the present invention, an insulation base 44 is provided on the circuit board 31 and the light-emitting chip 41 is fixed in the insulation base 44. Similarly, the gold plated wire 41 is bonded to connect to its corresponding circuit on the circuit board 31, and a sealant is poured into the insulation base to form a protection layer 45 to complete the assembly of a light-emitting diode 4 for providing the heat dissipation function by having the light emitting diode to directly contact the heat sink 51.

The prevent invention provides an improved structure of a light emitting diode heat sink, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A heat sink for a light emitting diode including a light emitting diode; a circuit board with the light emitting diode disposed thereon, and a through hole also being disposed on the circuit board corresponding to where the light emitting diode is provided; and a heat dissipation means provided to the through hole to directly contact and cool the light emitting diode.

2. The heat sink for a light emitting diode as clamed in claim 1, wherein the light emitting diode contains one or a plurality of light-emitting chip.

3. The heat sink for a light emitting diode as clamed in claim 2, wherein the through hole is provided corresponding to where the light-emitting chip is located.

4. The heat sink for a light emitting diode as clamed in claim 3, wherein the heat dissipation means directly contact the light-emitting chip.

5. The heat sink for a light emitting diode as clamed in claim 1, wherein the heat dissipation means relates to a heat sink, the heat sink is secured to the circuit board by means of the through hole and directly contacts the light emitting diode.

6. The heat sink for a light emitting diode as clamed in claim 5, wherein the heat sink extends further into the through hole to form a locating portion, and a heat dissipation portion further extends from the locating portion.

7. The heat sink for a light emitting diode as clamed in claim 6, wherein the heat dissipation portion is formed with multiple fins.

8. The heat sink for a light emitting diode as clamed in claim 5, wherein the heat sink relates to a metallic material.

9. The heat sink for a light emitting diode as clamed in claim 5, wherein the heat sink related to an aluminum material.

10. The heat sink for a light emitting diode as clamed in claim 5, wherein the heat sink relates to a copper material.

11. The heat sink for a light emitting diode as clamed in claim 5, wherein the heat sink relates to a ceramic compound material.

12. The heat sink for a light emitting diode as clamed in claim 5, wherein the heat sink relates to a graphite compound material.

13. The heat sink for a light emitting diode as clamed in claim 5, wherein the heat sink relates to a polymer admixed with a metallic oxide.

14. The heat sink for a light emitting diode as clamed in claim 1, wherein a circuit layer is provided on the circuit board; a light emitting chip is provided on the circuit layer, a gold plated wire is bonded to connect its corresponding circuit on the circuit board; and a sealant is poured to form an adhesive layer to complete the assembly of the light emitting diode.

15. The heat sink for a light emitting diode as clamed in claim 1, wherein an insulation base is disposed on the circuit board, a light emitting chip is mounted in the insulation base, a gold plated wire bonding is provided to connect its corresponding circuit on the circuit board; a sealant is poured into the insulation base to form a protection layer thus to complete the assembly of the light emitting diode.

16. The heat sink for a light emitting diode as clamed in claim 5, wherein a locating means is further provided to secure the heat sink and the through hole.

17. The heat sink for a light emitting diode as clamed in claim 16, wherein the locating means relates to a soldering method.

18. The heat sink for a light emitting diode as clamed in claim 16, wherein the locating means relates to an adhesive.

19. The heat sink for a light emitting diode as clamed in claim 18, wherein the adhesive is selected from polymer, thermal adhesive, thermal past, or phase change material (PCM), or any combination of them.
